(19) United States
(12) Patent Application Publication
(10) Pub. No.: US 2023/0334343 A1
(43) Pub. Date: Oct. 19, 2023

(54) SUPER-FEATURES FOR EXPLAINABILITY WITH PERTURBATION-BASED APPROACHES

(71) Applicant: Oracle International Corporation, Redwood Shores, CA (US)

(72) Inventors: Renata Khasanova, Zurich (CH); Nikola Milojkovic, Ueberlandstrasse (CH); Matteo Casserini, Zurich (CH); Felix Schmidt, Baden-Dattwil (CH)

(21) Appl. No.: 17/719,617

(22) Filed: Apr. 13, 2022

(51) Int. Cl. G06N 5/04

(52) U.S. Cl. CPC G06N 5/04

(57) ABSTRACT

In an embodiment, a computer hosts a machine learning (ML) model that infers a particular inference for a particular tuple that is based on many features. The features are grouped into predefined super-features that each contain a disjoint (i.e. nonintersecting, mutually exclusive) subset of features. For each super-feature, the computer: a) randomly selects many permuted values from original values of the super-feature in original tuples, b) generates permuted tuples that are based on the particular tuple and a respective permuted value, and c) causes the ML model to infer a respective permuted inference for each permuted tuple. A surrogate model is trained based on the permuted inferences. For each super-feature, a respective importance of the super-feature is calculated based on the surrogate model. Super-feature importances may be used to rank super-features by influence and/or generate a local ML explainability (MLX) explanation.

### FIELD OF THE INVENTION

The present invention relates to machine learning (ML) explainability (MLX). Herein are local explanation techniques for black box ML models based on super-feature importance established by feature permutation of dataset samples.

### BACKGROUND

Machine learning (ML) and deep learning are becoming ubiquitous for two main reasons: their ability to solve complex problems in a variety of different domains and growth in performance and efficiency of modern computing resources. However, as the complexity of problems continues to increase, so too does the complexity of the ML models applied to these problems.

Deep learning is a prime example of this trend. Other ML algorithms, such as neural networks, may only contain a few layers of densely connected neurons, whereas deep learning algorithms, such as convolutional neural networks, may contain tens to hundreds of layers of neurons performing very different operations. Increasing the depth of the neural model and heterogeneity of layers provides many benefits. For example, going deeper can increase the capacity of the model, improve the generalization of the model, and provide opportunities for the model to filter out unimportant features, while including layers that perform different operations can greatly improve the performance of the model. However, these optimizations come at the cost of increased complexity and reduced human interpretability of model operation.

Explaining and interpreting the results from complex deep learning models is a challenging task compared to many other ML models. For example, a decision tree may perform binary classification based on N input features. During training, the features that have the largest impact on the class predictions are inserted near the root of the tree, while the features that have less impact on class predictions fall near the leaves of the tree. Feature importance can be directly determined by measuring the distance of a decision node to the root of the decision tree.

Such models are often referred to as being inherently interpretable. However, as the complexity of the model increases (e.g., the number of features or the depth of the decision tree increases), it becomes increasingly challenging to interpret an explanation for a model inference. Similarly, even relatively simple neural networks with a few layers can be challenging to interpret, as multiple layers combine the effects of features and increase the number of operations between the model inputs and outputs. Consequently, there is a requirement for alternative techniques to aid with the interpretation of complex ML and deep learning models.

ML explainability (MLX) is the process of explaining and interpreting ML and deep learning models. MLX can be broadly categorized into local and global explainability:
Local: Explain why an ML model made a specific prediction corresponding to a given sample to answer a question such as why did the ML model make a specific prediction.
Global: Understand the general behavior of the ML model as a whole to answer questions such as how does the ML model work or what did the ML model learn from training data.

An ML model accepts as input an instance such as a feature vector that is based on many features of various datatypes that respectively have many or an infinite amount of possible values. Each feature provides a dimension in a vast multidimensional problem space in which a given multi-featured input is only one point. Even though a global explanation may be based on many input instances, most of the multidimensional problem space is missed by those instances, and the instances are separated from each other by huge spatial gaps. Thus, for explaining a particular inference by an ML model for a particular input that almost always falls within such a spatial gap of unknown behavior of the ML model, a global explanation may have low accuracy. An approach such as Shapley for local explaining requires a number of input instances and output inferences that grows exponentially with the number of features because, by design, Shapley explores relations between features, which is combinatorically intractable. In other words, best of breed local explainers are not scalable and may be computationally overwhelmed by a wide feature vector.

### BRIEF DESCRIPTION OF THE DRAWINGS

In the drawings:

FIG. 1 is a block diagram that depicts an example computer that provides machine learning (ML) explainability (MLX) for a black box ML model based on permuting a tuple to explain to generate permuted tuples;

FIG. 2 is a flow diagram that depicts an example computer process that can provide local MLX for a black box ML model based on permuting a tuple to explain to generate permuted tuples;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

State of the art machine learning (ML) explanation (MLX) techniques are based on a problem space having many dimensions known as features. The space may consist of hundreds of features. A subset of features may be related based on a modality such as features from a same source or features cooperating to describe a same aspect. Analyzing and presenting related features together as a modality may be interpreted by a human more intuitively and faster and in a way that better relates an MLX explanation to possible subsequent actions and investigation such as trouble shooting a source of a modality. For example, each modality may have its own semantics that a human appreciates.

Instead of supporting modalities, state of the art MLX treats the hundreds of features as independent features that supposedly are not interrelated. A result is that an MLX explanation is more complicated and, because complexity and usability are inversely correlated for human factors, the explanation is harder to understand and thus less useful. Features in a same modality are more likely to be statistically correlated, which may make existing MLX techniques slower or less reliable as explained herein.

A super-feature is a subset of features that are based on a same modality and that are processed together for MLX. Herein are explanation techniques that extract local super-feature importance for a trained ML or deep learning (DL) model, referred to as a black box model. To locally explain the behavior of the ML model, permutation-based MLX techniques evaluate how the predictions of the ML model change on permuted versions of an instance to be explained. A super-feature that, when permuted, has a much larger effect on the ML model's predictions is considered to be more important than a permuted super-feature that results in little-to-no change in the ML model's predictions. This approach includes highly-stable, linear-time, permutation-based, model-agnostic, local feature attribution for MLX.

As a combination of values of individual features, techniques herein sample a super-feature value from an empirical marginal distribution of a reference dataset for increased realism that avoids assessing the importance of a features value combination that is completely outside the domain of realistic value combinations, even when individual values in the combination are themselves realistic. By using the underlying data distributions for permutation, overall quality (i.e. accuracy) of the explanations may quantitatively increase because the generated data instances can explore parts of the ML model's multidimensional latent space that may be encountered by future realistic instances that were not observed in the reference dataset. Likewise, this approach may decrease the number of instances that must be generated to obtain an explanation of equal quality, thereby decreasing consumption of time and space.

Data distribution is crucial for realism. Perturbing an original instance to generate a new instance may lead to out-of-distribution samples. Unrealistic data is problematic because it may confuse an ML model, which decreases accuracy of inferencing such as classification. Unrealistic instances occur in regions of a multidimensional problem space where the ML model is unreliable or even unstable such as prone to unpredictable discontinuities in the prediction solution space that prevent an instance from being modified or used as-is in the real world as predicted. Thus, unrealistic instances have little explanatory value and may undermine confidence in MLX.

Important local MLX use cases are interactive and do not tolerate latency well. Customer experience (CX) may be at stake. For example, local MLX may be used during a phone conversation such as with a support or sales agent. A localized neighborhood of permuted instances should be quickly generated. Optimizing the above concerns and criteria is expensive with high dimensional datasets having many constituent datatypes.

An embodiment may generate and train an additional ML model that is not the black box ML model. The additional ML model is referred to herein as a surrogate model or, due to human understandability, an interpretable model.

In practice, the black box ML model learns a vast multidimensional space of a huge training corpus and is more complex than the surrogate model that only needs to learn a small neighborhood that is based on a particular MLX invocation. The surrogate model may have a straightforward and streamlined architecture such as a decision tree or a linear regression. For example, coefficients of a linear regression or level numbers of a decision tree may be more or less directly used as importance scores of super-features.

The surrogate model may or may not use feature vectors that directly encode super-features instead of features. A value of a super-feature is encoded as a row offset into a corpus of original tuples. Thus, values may be encoded for the surrogate model as a few integers for a few super-features, even though there may be dozens of features within each super-feature. That dimensionality reduction means that the surrogate model can train in less time and in less space without sacrificing accuracy.

In an embodiment, a computer hosts a machine learning (ML) model that infers a particular inference for a particular tuple that is based on many features. The features are grouped into predefined super-features that each contain a disjoint (i.e. nonintersecting, mutually exclusive) subset of features. For each super-feature, the computer: a) randomly selects many permuted values from original values of the super-feature in the original tuples, b) generates permuted tuples that are based on the particular tuple and a respective permuted value, and c) causes the ML model to infer a respective permuted inference for each permuted tuple. A surrogate model is trained based on the permuted inferences. For each super-feature, a respective importance of the super-feature is calculated based on the surrogate model. Super-feature importances may be used to rank super-features by influence and/or generate a local ML explainability (MLX) explanation.

### 1.0 Example Computer

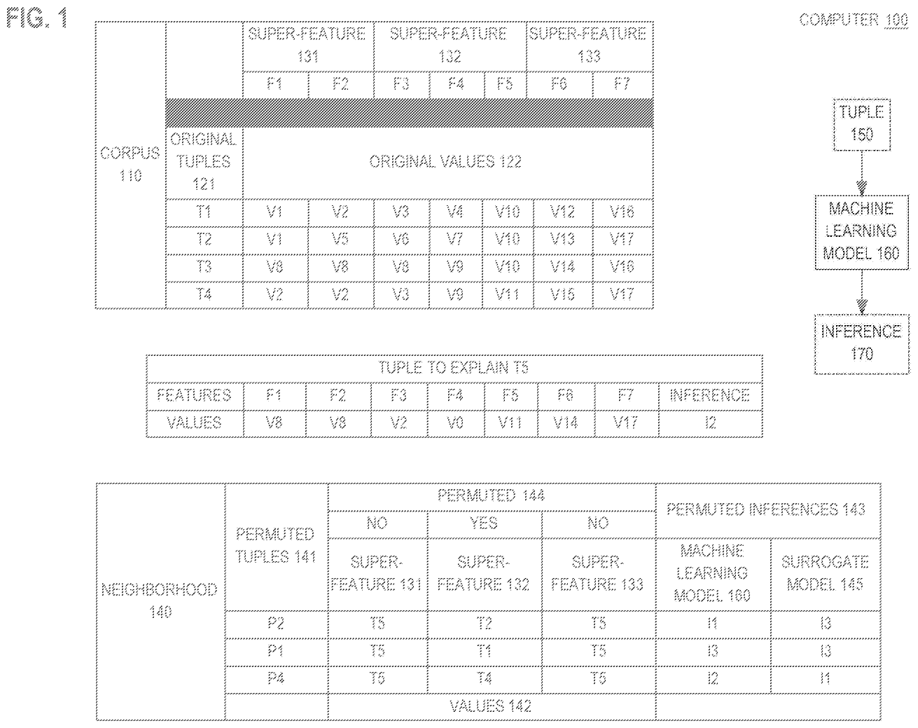

FIG. 1 is a block diagram that depicts an example computer 100, in an embodiment. Computer 100 provides machine learning (ML) explainability (MLX) for black box ML model 160 based on permuting tuple to explain T5 to generate permuted tuples 141. Based on permuted inferences 143, super-features 131-133 may be scored and ranked for relative importance from which a local MLX explanation may be generated. Computer 100 may be one or more of a rack server such as a blade, a personal computer, a mainframe, a virtual computer, a smartphone, or other computing device.

### 1.1 Black Box Model

In various embodiments, hosted in memory of computer 100 is already-trained ML model 160 that may operate for classification, regression, prediction, anomaly detection, clustering, or other ML purpose. In operation, ML model 160 is applied to a tuple such as tuple 150 to generate an inference such as inference 170 that may be a class or a value of a regression or prediction. In an embodiment, inference 170 contains one or more numeric scores or probabilities such as a respective probability for each of multiple classes. In an embodiment, inference 170 is numeric and compared to a threshold to detect whether or not tuple 150 is anomalous. Tuples are explained later herein.

ML model 160 may be a black-box model that has an unknown, opaque, or confusing architecture that more or less precludes direct inspection and interpretation of the internal operation of ML model 160. In an embodiment not shown, ML model 160 is hosted in a different computer that is not computer 100, and computer 100 applies techniques herein by remotely using ML model 160. For example, computer 100 may send tuple 150 to ML model 160 over a communication network and responsively receive inference 170 over the communication network. For example, computer 100 and ML model 160 may be owned by different parties and/or hosted in different data centers. In various embodiments that host ML model 160 in computer 100, techniques herein may or may not share an address space and/or operating system process with ML model 160. For example, inter-process communication (IPC) may or may not be needed to invoke ML model 160.

### 1.2 Machine Learning Explainability (MLX)

Approaches herein generate local explanations of ML model 160. As discussed later herein, a local explanation explains inference I2 by ML model 160 for tuple to explain T5 that may be known or new. As discussed below, corpus 110 and/or ML model 160 participate in a sequence of phases that include: training of ML model 160 and MLX invocation that generates neighborhood 140 based on tuple to explain T5 before generating a local explanation.

In various scenarios, tuple to explain T5 and its inference I2, and/or ML model 160 are reviewed for various reasons. MLX herein can provide combinations of any of the following functionalities:
Explainability: The ability to explain the local reasons why inference I2 occurred for tuple to explain T5
Interpretability: The level at which a human can understand the explanation
What-If Explanations: Understand how changes in tuple to explain T5 may or may not cause same inference I2
Model-Agnostic Explanations: Explanations treat ML model 160 as a black box, instead of using internal properties from ML model 160 to guide the explanation

For example, the explanation may be needed for regulatory compliance. Likewise, the explanation may reveal an edge case that causes ML model 160 to malfunction for which retraining with different data or a different hyperparameters configuration is needed.

### 1.3 Corpus of Original Tuples

Training of ML model 160 entails a training corpus that contains training tuples. In various embodiments, the training corpus is or is not corpus 110. In various embodiments, training of ML model 160 is unsupervised or supervised, which means that the tuples of the training corpus are unlabeled or each tuple is labeled with a respective known correct inference. In any case, ML model 160 is already trained in FIG. 1.

Corpus 110 may or may not be used in any of training, validation, and testing of ML model 160. Essentially, original tuples 121 are a small portion of a multidimensional problem space, with each of features F1-F7 providing a respective dimension, that ML model 160 could map to inferences that would provide an additional dimension to a multidimensional solution space.

### 1.4 Corpus Metadata

Corpus 110 includes metadata and data that computer 100 stores or has access to. In an embodiment, corpus metadata is stored or cached in volatile memory, and corpus data is stored in nonvolatile storage that is local or remote. Corpus data defines a portion of the multidimensional problem space and includes original tuples 121. Original tuples 121 are respective points in the multidimensional problem space. Original tuples 121 includes individual original tuples T1-T4 that collectively contain original values 122 that includes individual values V1-V17. Each of original tuples 121 contains a respective value for each of features F1-F7. For example as shown, the value of feature F1 in original tuples T1-T2 is value V1.

Corpus metadata generalizes or otherwise describes corpus data. Corpus metadata includes features F1-F7 that can describe tuple 150 that is shown with a dashed outline to demonstrate that tuple 150 may be any individual tuple of tuples 121, 141, or T5.

### 1.5 Feature Engineering

Tuple 150 contains a respective value for each of features F1-F7. In an embodiment, tuple 150 is, or is used to generate, a feature vector that ML model 160 accepts and that contains more or less densely encoded respective values for features F1-F7. Each of features F1-F7 has a respective datatype. For example, features F1 and F3 may have a same datatype. A datatype may variously be: a) a number that is an integer or real, b) a primitive type such as a Boolean or text character that can be readily encoded as a number, c) a sequence of discrete values such as text literals that have a semantic ordering such as months that can be readily encoded into respective numbers that preserve the original ordering, or d) a category that enumerates distinct categorical values that are semantically unordered.

Categories are prone to discontinuities that may or may not seemingly destabilize ML model 160 such that different categorical values for a same feature may or may not cause ML model 160 to generate very different inferences. One categorical feature may be hash encoded into one number in a feature vector or n-hot or 1-hot encoded into multiple numbers. For example, 1-hot encoding generates a one for a categorical value that actually occurs in a tuple and also generates a zero for each possible categorical value that did not occur in the tuple.

Tuple 150 may represent various objects in various embodiments. For example, tuple 150 may be or represent a network packet, a record such as a database table row, or a log entry such as a line of text in a console output logfile. Likewise, features F1-F7 may be respective data fields, attributes, or columns that can occur in each object instance.

Inference 170 is shown with a dashed outline to demonstrate that inference 170 may be any individual inference of permuted inferences 143 or inference I2 of tuple to explain T5. In some examples, inference 170 may be a binary classification or an anomaly score that indicates whether or not tuple 150 is anomalous such as based on a threshold. When ML model 160 detects an anomaly in a production environment, an alert may be generated to provoke a human or automated security reaction such as terminating a session or network connection, rejecting tuple 150 from further processing, and/or recording, diverting, and/or alerting tuple 150 for more intensive manual or automatic inspection and analysis.

### 1.6 Sampling Neighborhood

ML model 100 generates or previously generated inference I2 for original tuple to explain T5. In an embodiment that classifies tuple 150 into one of four mutually exclusive classes, inference 170 may be any of inferences I1-I4. However, ML model 160 may have imperfect accuracy that sometimes causes inference 170 to be wrong and not match a label of tuple 150 that is an actually known correct class of tuple 150.

Each of original tuples 121 may be a point in a multidimensional problem space defined by features F1-F7. Although there may be hundreds of thousands of original tuples 121 that each may be a distinct combination of values of features F1-F7 that is a distinct point in the multidimensional problem space, most or nearly all possible points in the multidimensional problem space do not occur in original tuples 121. Thus, inference 170 is unknown for most or nearly all possible points in the multidimensional problem space. Thus, a global explanation based on original tuples 121 would likely have limited accuracy, especially because known points in the multidimensional problem space are usually separated by regions with many possible tuples whose inference 170 is unknown.

Computer 100 generates a local explanation that is more accurate than a global explanation as follows. Inference 170 depends on the values of features F1-F7 in tuple 150. By concentrating the generation of an explanation on the neighborhood of possible points that surround tuple to explain T5 in the multidimensional problem space, the accuracy of the local explanation is increased. Neighborhood 140 uses sampling of original values 122 to explore the locale around tuple to explain T5 as follows.

Neighborhood 140 generates permuted tuples 141 that are probabilistic variations of tuple to explain T5 based on original values 122. Perturbation entails synthesizing new tuples as imperfect copies of old tuples. Permutation is different from other kinds of perturbation because permutation does not entail a randomly generated value of a feature and does not entail a predefined meaningless special value of a feature such as a null or zero.

### 1.7 Beyond Lime and Kernel SHAP

How the state of the art generates perturbed tuples depends on how those perturbed tuples are used to detect feature importance and generate ML explanations (MLX) as explained later herein. Benefits of permutation are not achieved by other kinds of perturbation due to design limitations as follows.

For example, Shapley additive explanation (SHAP) is presented in non-patent literature (NPL) “A unified approach to interpreting model predictions” published by Scott Lundberg et al in Advances In Neural Information Processing Systems 30 (2017) that is incorporated in its entirety herein. Due to SHAP's additive approach, perturbation with SHAP's so-called “missing value” is a predefined meaningless special value of a feature such as a null or zero, which may confuse and destabilize inferencing by ML model 160.

SHAP is unreliable in additional ways. Most embodiments of ML model 160 are non-linear, such as a neural network. As explained later herein, related features are grouped into super-features that correspond to natural modalities. The values distributions of related features often are not independent, which means there may be correlations between features. If SHAP is used with an ML model that is not linear or used with features that are not independent, then SHAP is unreliable unless perturbed tuples are exhaustively generated according to combinatorics that may be computationally intractable.

As another example, local interpretable model-agnostic explanations (LIME) is presented in NPL “Why should I trust you? Explaining the predictions of any classifier” published by Marco Ribeiro et al in Proceedings of the 22nd ACM SIGKDD International Conference on Knowledge Discovery and Data Mining (2016) that is incorporated in its entirety herein. LIME's perturbation entails a so-called “grayed out” value that is equivalent to SHAP's “missing value”.

In ways discussed later herein, embodiments herein may combine SHAP or LIME or both (i.e. kernel SHAP as presented in the SHAP NPL) with the following novel permutation techniques. State of the art perturbation by LIME and kernel SHAP is prone to generating unrealistic perturbed tuples because a missing value (e.g. null or zero) is always or almost always unrealistic. Lack of realism is compounded when multiple features are missing values in a perturbed tuple, which is unavoidable with SHAP.

### 1.8 Realistic Combinations of Values

To some extent, lack of realism may be mitigated by using natural values for perturbation instead of a predefined blank value. For example, a perturbed value may be randomly generated from a natural range of a feature. If the feature is a wheel count of a vehicle that may range from a unicycle to a freight truck, there may be value(s) that are in the range but still unnatural such as five wheels.

Even if values are limited to natural values such as values that actually occur for feature F5 in original values 122, a set of perturbed tuples may have an unrealistic distribution. For example, values V10-V11 are the only values for feature F5 in original values 122 but, because value V10 predominates for feature F5 in original values 122, it would be unrealistic to generate an equal count of perturbed tuples that respectively have values V10-V11 for feature F5. In other words, realistic perturbed feature values may still cause generation of an unrealistic neighborhood having realistic perturbed tuples.

Even if value distributions are preserved, a compound value of a combination of features may be unrealistic. For example, feature F1 may be the score of a team that won an American professional football game, and feature F2 may be the score of a team that lost that game. A score of 6-0 or a score of 6-1 is possible, but a score of 1-1 is naturally impossible.

In those various ways, a perturbed tuple may have a value or combination of values that is unrealistic or unnatural, and a neighborhood composed of realistic perturbed tuples may itself be unrealistic due to unrealistic or unnatural frequencies. Permutation herein avoids those pitfalls. Thus, neighborhood 140 is more realistic than the state of the art and provides benefits discussed later herein.

### 1.9 Example Super-Features

Permutation herein is based on super-features 131-133 that each contain a disjoint (i.e. nonintersecting, mutually exclusive) subset of features F1-F7. Each super-feature contains multiple features. A feature is contained in exactly one super-feature. For example, super-feature 131 contains features F1-F2. Super-features 131-132 contain different respective counts of features.

A super-feature is based on a modality, which is an information domain consisting of related features that share an origin or purpose or that describe an object or a component of an object. There is a one-to-one correspondence of super-features to modalities. The following Table 1 provides examples of modalities, super-features, and features that may occur in tuples that each represent a respective database statement in a log of a database server.

| Super-feature | Modality | Feature | Meaning |
|---|---|---|---|
| 131 | Database connection | F1 | All or part of a |
| | and database session | | connection URL of |
| | | | ODBC or JDBC |
| | | F2 | Session duration |
| 132 | Kind of database | F3 | Language |
| | statement | F4 | Verb |
| | | F5 | State |
| 133 | Result of statement | F6 | Error code |
| | | F7 | Rows returned |

In above Table 1 for super-feature 131, feature F1 may be or contain a part of an open database connectivity (ODBC) or Java ODBC (JDBC) uniform resource locator (URL) that was used to establish a network connection and a database session. Example connection string parts include standard URL parts (e.g. protocol, server host, and network port number) and ODBC/JDBC specific parts in the path or query parameters such as a name of a database, schema, or user account. Feature F2 may indicate how old is the database session that issued the database statement.

In above Table 1 for super-feature 132, feature F3 may be a 1-hot encoding of the dialect of structured query processing language (SQL) of the database statement such as data definition language (DDL), a data manipulation language (DML), data query language (DQL), and transaction control language (TCL). Feature F4 may be a 1-hot encoding of the verb of the database statement such as SELECT, INSERT, DELETE, UPDATE, CREATE, DROP, GRANT, BEGIN, and COMMIT. Feature F5 may be an n-hot encoding of the state or context of the database statement such as: outside of a transaction, inside a demarked transaction, auto-committed transaction, and prepared statement.

In above Table 1 for super-feature 133, feature F6 may be a return code of the database statement such as an error code. Feature F7 may be a count of rows in the result set returned by the database statement.

Other examples not shown in Table 1 include a schema super-feature that contains features such as an n-hot encoding of database tables referenced by a database statement. A query criteria super-feature may contain features that describe a WHERE clause such as a count of joins specified, a LIMIT clause on results, a sorting direction, and the DISTINCT keyword.

### 1.10 Permutation of Super-Features

As discussed above, permutation is based on super-features 131-133 such as those in above Table 1. Permuted tuples 141 contains multiple (e.g. three as shown) permuted variations of tuple to explain T5 for each of super-features 131-133. Each permuted tuple is almost a perfect copy of tuple to explain T5, except that the value of one of super-features 131-133 is permuted (i.e. not a copy). Permuted 144 shows YES to demonstratively indicate that super-feature 132 is permuted in the shown subset of permuted tuples 141. However, permuted tuples 141 also contains an equal amount of unshown tuples that respectively permute each of other super-features 131 and 133. In other words, permuted tuples 141 may have a count of tuples that is a multiple of a count of super-features 131-133.

Permuted 144 shows NO for super-features 131 and 133 that means that super-features 131 and 133 are not permuted in permuted tuples P1-P2 and P4. The values of super-features 131-133 for permuted tuple P1-P2 and P4 are shown in respective rows of values 142. The values of super-features 131 and 133 both are shown as “T5” for permuted tuple P1-P2 and P4, which means that the values of super-features 131 and 133 for permuted tuples P1-P2 and P4 are the same as for tuple to explain T5.

Super-features 131 and 133 respectively contain features F1-F2 and F6-F7. Thus, the values of features F1-F2 and F6-F7 are the same in tuples T5, P1-P2, and P4. For example, the value of feature F6 is V14 in all of tuples T5, P1-P2, and P4.

Because super-feature 132 is permuted for permuted tuples P1-P2 and P4, values of super-feature 132 for permuted tuples P1-P2 and P4 are not taken from tuple to explain T5, but are instead taken from respective original tuples 121 respectively for permuted tuples P1-P2 and P4. For example, the value of super-feature 132 for permuted tuple P2 is shown as “T2”, which means that the value of super-feature 132 for tuples P2 and T2 is the same.

Super-feature 132 contains features F3-F5. Thus, the values of features F3-F5 are the same in tuples P2 and T2. For example, the value of feature F3 is V6 in both of P2 and T2.

Permuted values of super-feature 132 are randomly sampled from values of super-feature 132 in original values 122. For example as shown for super-feature 132 in values 142, permuted tuples P1-P2 and P4 have respective values of super-feature 132 from original tuples T1-T2 and T4. Thus, the values distribution of super-feature 132 in permuted tuples P1-P2 and P4 is bounded by the same value range as the original values of super-feature 132 and should have more or less a same probability distribution of value frequencies.

Because sampling is random, some statistical distortions may occur. For example, some of original tuples 131 might not be sampled for some or all of super-features 131-133. For example for super-feature 132, original tuple T3 is not sampled.

In an embodiment, random selection entails generating real numbers that are inclusively or exclusively between zero and one, and such a real number can be scaled to fit into an integer range that is limited by a count of original tuples 121. For example, the random number may be scaled to be in a range of 0-3 for original tuples T1-T4 respectively. In various embodiments, a permuted tuple should not match: a) tuple to explain T5 nor b) any other permuted tuple. For example if a randomly generated permuted value causes such a match, then another permuted value may be randomly and repeatedly generated until a unique permuted tuple is generated.

For example, neighborhood 140 may be designed to only generate permuted tuples having distinct combinations of super-features values. Tuple to explain T5 (and thus values 142) may contain a value for an unpermuted super-feature that does not occur for that super-feature and/or any other super-feature in original values 122. For example as shown, the value of super-feature 133 that contains features F6-F7 in tuple to explain T5 is V14,V17 that is a combination that does not occur for super-feature 133 in original values 122.

Likewise, tuple to explain T5 (and thus values 142) may contain a value for a feature in an unpermuted super-feature that does not occur for that feature and/or any other feature in original values 122. For example as shown, value V0 occurs for feature F4 in tuple to explain T5 but not for any of features F1-F7 in original values 122. In those ways, tuple to explain T5 may be absent from original tuples 121.

### 1.14 Surragate Model

LIME and kernel SHAP have (and embodiments herein may have) surrogate model 145 that is an additional ML model that is not ML model 160. ML model 160 is referred to herein as a black box model, an opaque model, a target model, or a model to be explained. Due to human understandability, surrogate model 145 is referred to herein as an interpretable model.

In practice, ML model 160 learns a vast multidimensional space (e.g. at least corpus 110) and is more complex than surrogate model 145 that only needs to learn neighborhood 140 and tuple to explain T5. Surrogate model 145 may have a straightforward and streamlined architecture such as a decision tree or a linear regression.

Less complex (i.e. more understandable) MLX explanations is a motivation of LIME and kernel SHAP that is only partially fulfilled in the state of the art due to lack of super-features. Dimensionality reduction achieved by super-features is an improvement in two important ways.

First, MLX explanations herein are based on and expose the user to super-features instead of features. Such an MLX explanation is less complex due to increased granularity of explanation details. Less complexity of presentation means accelerated human comprehension.

For example, state of the art kernel SHAP may generate an explanation that intermingles unrelated features such as by ranking top four features by descending importance as features F5, F7, F4, F3. A comparable explanation herein may instead designate super-feature 132 as most important, without the user having to disentangle features of different natural modalities such as feature F7 that is not in super-feature 132.

Second, surrogate model 145 may or may not use feature vectors for tuples 141 and T5 that directly encode super-features instead of features. Herein a super-feature may be encoded as a row offset into original tuples 121, with tuple to explain T5 being an additional row. For example, original tuples T1-T4 may be identified by respective integer offsets 1-4, and tuple to explain T5 may be identified by offset 5.

### 1.11 Surrogate Feature Vector

Thus, values 142 may be encoded for surrogate model 145 as integer triplets if there are three super-features, even though there may be dozens of features within each super-feature. For example, permuted tuple P2 that is shown in values 142 as a triplet T5,T2,T5 may be encoded as an integer triplet 5,2,5. That dimensionality reduction means that surrogate model 145 can train in less time and in less space without sacrificing accuracy.

Dimensionality reduction by super-features is generally applicable to any problem domain, unlike state of the art LIME. For example, the LIME NPL presents two exemplary problem domains, natural language processing (NLP) and computer vision, which are carefully expressed with Boolean encodings that effectively are n-hot encodings such that each Boolean represents one feature. While convenient, one Boolean for each of features F1-F7 is suitable only for simple problems and lacks the general applicability of feature engineering herein.

For example, feature F6 has four distinct values V12-V15 in original values 122 that cannot be encoded as one Boolean. For example, LIME's exemplary NLP is based on a Boolean encoding that has less information than a bag of words, which itself is notoriously low information. Unlike LIME, feature engineering herein provides dimensionality reduction without being inherently lossy.

In several ways, super-features are not the same as LIME's super-pixels. Each of tuples 121, 141, and T5 have a same count of super-features. LIME's pictures in a same corpus do not have a fixed count of super-pixels, such that a first picture may have more super-pixels than a second picture that is the same size as the first picture. LIME's count of super-pixels depends on the content of a picture. A count of super-features does not depend on original values 122.

### 1.12 Training Surrogate Model

Inferences by ML models 145 and 160 for permuted tuples 141 are shown in permuted inferences 143. For example for permuted tuple P1, ML models 145 and 160 unanimously infer inference 13. However, ML models 145 and 160 are functionally different in three important ways, which may cause ML models 145 and 160 to generate different respective inferences I1 and I2 for same perturbed tuple P4.

First, ML model 160 is more complex than surrogate model 145, which may cause divergent inferences. Second, ML models 145 and 160 have distinct respective training corpuses such that surrogate model 145 trains with only tuples 141 and T5, whereas ML model 160 trains with at least original tuples 121. Third, ML models 145 and 160 train with respective corpuses that contain very different respective counts of tuples.

Two columns are shown in permuted inferences 143. Before supervised training of surrogate model 145, ML model 160 is applied to permuted tuples 141 to generate respective inferences in the left column of permuted inferences 143.

Supervised training of surrogate model 145 uses neighborhood 140 and tuple to explain T5 as a training corpus and uses the left column of permuted inferences 143 and inference I2 of tuple to explain T5 as training labels. During supervised training, surrogate model 145 is applied to permuted tuples 141 to generate training inferences in the right column of permuted inferences 143. Training inferences may be more or less inaccurate.

That is, the left and right columns of permuted inferences 143 may disagree for some permuted tuples. A disagreement as to the inference for a permuted tuple represents training loss, which is used for reinforcement learning by surrogate model 145. For example, loss may be measured and used to adjust the internal parameters (e.g. coefficients) in surrogate model 145 to accomplish learning such as by back propagation as explained later herein. A result of training is that surrogate model 145 should become able to generate a same inference as ML model 160 would generate for most of permuted tuples 141.

Because generation of permuted tuples 141 and training surrogate model 145 are both faster than state of the art LIME and kernel SHAP, an MLX explanation can be more or less instantaneously generated on demand for any tuple to explain T5. For example, MLX herein may be used by customer support personnel during live phone calls and without delay.

### 1.13 Importance Scores

Earlier herein is discussed the possibility that only one super-feature is permuted in a permuted tuple. In an embodiment, a few (i.e. multiple) super-features are permuted in each of some permuted tuples. For example, a first subset of permuted tuples 141 may permute one super-feature, a second subset may permute two super-features, and a third subset may permute three super-features. Likewise, super-features 131-132 may be permuted in some of permuted tuples 141, and super-features 132-133 may be permuted in others of permuted tuples 141. That increases the density of neighborhood 140, which may increase the accuracy of surrogate model 145.

Because surrogate model 145 is interpretable, importances of super-features 131-133 can be more or less directly extracted from surrogate model 145. For example if surrogate model 145 is a decision tree or a linear regression, coefficients of the linear regression or level numbers of the decision tree may be more or less directly used as importance scores of super-features 131-133.

Super-features 131-133 may be ranked (i.e. sorted) by importance score to establish a relative ordering of influence of super-features 131-133 on the inferential operation of ML model 160. For example, super-feature 132 may be more influential than super-feature 131 on the operation of ML model 160. Thus, super-feature 132 should have more explanatory power for MLX than does super-feature 131. A local explanation of ML model 160 would emphasize super-feature 132 over super-feature 131.

Within memory of computer 100, a local explanation may be a data structure that is based on or contains a ranking of super-features 131-133 by importance score and/or exclude a threshold count of least influential super-features or super-features whose importance score falls below a threshold. For example a local explanation may be limited to a top two most influential super-features or a variable count of super-features having an importance score of at least 0.4. Explanation generation is discussed later herein.

### 1.14 Tuple Weighting

Earlier herein is discussed the possibility that all of permuted tuples 141 and their permuted inferences 143 have a same impact on training surrogate model 145 and thus a same impact on feature importance, which may be inaccurate. For the same reason that a local explanation may be more accurate than a global explanation, permuted tuple P4 may have more explanatory power than permuted tuple P1 if permuted tuple P4 is more similar to tuple to explain T5 than is permuted tuple P1.

For that reason, permuted tuples 141 and their training losses as discussed above may be weighted for averaging according to how similar is each of permuted tuples 141 to tuple to explain T5. Likewise, training of surrogate model 145 may be based on that weighting of permuted tuples 141.

In an embodiment, tuple distance (i.e. dissimilarity from tuple to explain T5) may be measured for weighting a permuted tuple based on a count of super-features permuted. For example, permuted tuple has only one permuted super-feature 132, and the distance between tuples T5 and P2 may be one.

Tuple weight may be inversely correlated to distance, and a higher weight should be derived from a lower distance. In an embodiment, tuple distance for weighting may be based on a sum of counts of features in super-features permuted. For example, permuted tuple P2 has only one permuted super-feature 132 that contains three features F3-F5, and the distance between tuples T5 and P2 may be three.

In an embodiment, distance for tuple weighting is measured as a sum or a multidimensional cartesian distance (i.e. less than a sum) of differences of values for each of features F1-F7, no matter which super-feature(s) are permuted. Regardless of whether distances are measured for features or super-features, the distance for a feature or super-feature that is not permuted is always zero when contributing to a sum or count.

Feature values may be normalized in various ways for feature encoding and/or distance calculation. For example, a difference/distance between adjacent months in a year may be less than a distance between adjacent days in a week. A Mahalanobis distance is based on feature values that are normalized to standard deviations of the respective features. For example if most prices are in range of $1-$100, then a Mahalanobis distance between $30 and $90 may be less than the distance between $90 and $110.

### 2.0 Example Importance Scoring Process

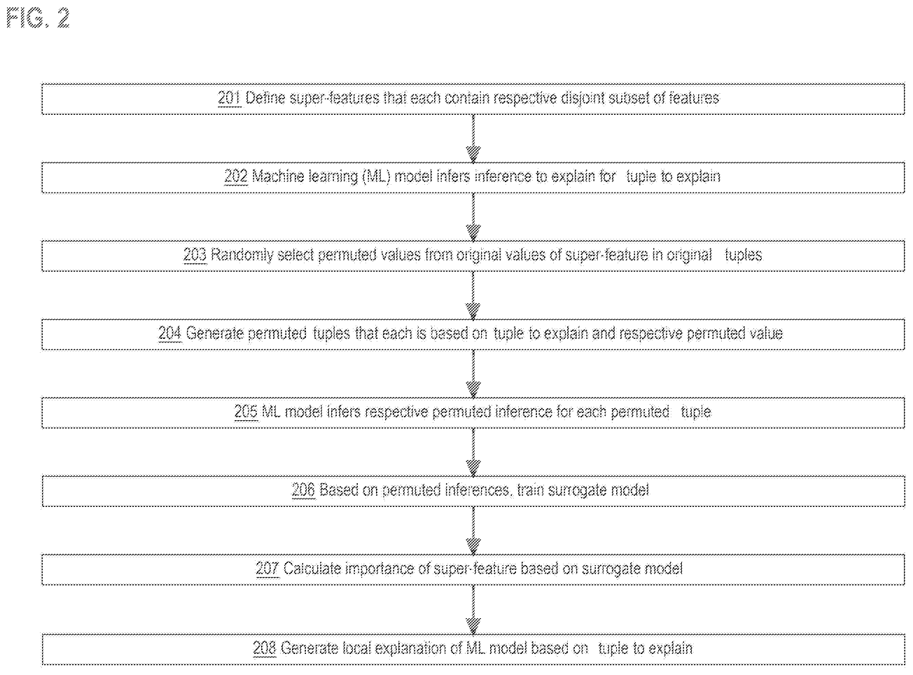

FIG. 2 is a flow diagram that depicts an example process that an embodiment of computer 100 may perform to provide machine learning (ML) explainability (MLX) for black box ML model 160 based on permuting tuple to explain T5 to generate permuted tuples 141. FIG. 2 is discussed with reference to FIG. 1.

Herein, an MLX lifecycle for ML model 160 has three phases. Each MLX invocation entails a distinct tuple to explain T5. No matter how may tuples to explain T5 may occur, a preparatory design phase occurs only once and entails step 201 that defines super-features 131-132 that each contain a respective disjoint subset of features.

An empirical phase generates respective inferences for one or more distinct tuples to explain T5 and entails step 202. The ordering of steps 201-202 may be reversed. In step 202, ML model 160 infers inferences 170 to explain tuples to explain T5.

For example, tuples to explain T5 may be archived and historic or may be live and streaming. Step 202 itself may be live or historic. For example, inference I2 for tuple to explain T5 may or may not be archived.

A runtime phase calculates importances for super-features 131-133 for a given tuple to explain T5 and may optionally perform MLX. The runtime phase entails steps 203-208 are repeated for each tuple to explain T5. Steps 203-207 calculate importances of super-features 131-133. Repetition of steps 203-204 for each of super-features 131-133 fully populates values 142 and the left column of permuted tuples 141.

Step 203 randomly selects permuted values from original values 122 of a super-feature in original tuples 121. Random selection by step 203 entails random generation of only an offset into an array of original tuples 121. Random selection by step 203 does not entail identification of values within original values 122.

Step 204 generates permuted tuples that each is based on tuple to explain T5 and a respective permuted value of a super-feature. Step 204 regenerates a distinct neighborhood 140 for each tuple to explain T5.

Step 204 generates one or two feature vectors that redundantly represent a permuted tuple. A target feature vector has a format that ML model 160 accepts. In a first embodiment, ML model 160 and surrogate model 145 accept the same target feature vector format.

In a second embodiment, step 204 generates another feature vector that has a format that surrogate model 145 accepts but is different from the format of the target feature vector. A surrogate feature vector contains only integer offsets of tuples such as offsets 1-4 for original tuples 121 and offset 5 for tuple to explain T5. For example, permuted tuple P2 that is shown in values 142 as a triplet T5,T2,T5 may be encoded as an integer triplet 5,2,5. Unlike LIME and kernel SHAP, the surrogate feature vector does not contain Booleans.

The two feature vectors differ as follows. The surrogate feature vector is narrower because it contains fewer elements and fewer bytes than the target feature vector. The surrogate feature vector represents homogenous data that are integer offsets of tuples. The target feature vector instead represents heterogenous data because features F1-F7 may have different datatypes.

Step 204 generates the target feature vector that contains values for features F1-F7. For example, permuted tuple P2 that is shown in values 142 as a triplet T5,T2,T5 may be encoded as a tuple having seven values that are V8,V8,V5,V6,V7,V14,V17, where only the bold values V5-V7 are taken from original tuple T2 for super-feature 132. Values for features F1-F2 and F6-F7 of super-features 131 and 133 are instead taken from tuple to explain T5.

Various embodiments of step 204 may populate the target feature vector by accessing original values 122 in different ways. Original values 122 may be a two dimensional array from which a feature value may be accessed using a row offset of an original tuple and a column offset of a feature. A value of a super-feature may be accessed using a range of column offsets of features in the super-feature.

Original values 122 may be vertically sliced into two-dimensional arrays that each contain feature values of a respective super-feature or into a one-dimensional array for each feature. A feature value within a slice may be accessed as discussed above.

In step 205, ML model 160 infers a respective permuted inference for each permuted tuple. Repetition of step 205 fully populates the left column of permuted inferences 143 based on permuted tuples 141.

Step 206 generates and supervised trains surrogate model 145 using neighborhood 140 and tuple to explain T5 as a training corpus that is encoded into surrogate feature vectors and using the left column of inferences 143 and inference I2 of tuple to explain T5 as training labels for supervision.

Step 206 regenerates and retrains surrogate model 145 for each distinct tuple to explain T5. Each instance of surrogate model 145 is distinct due to training with a respective distinct neighborhood 140. Supervised training of surrogate model 145 is discussed earlier herein.

Step 207 calculates respective importances of super-features 131-133 based on surrogate model 145. In an embodiment, steps 206-207 are combined such that importances of super-features 131-133 are established by training surrogate model 145. Because surrogate model 145 is interpretable, step 207 can more or less directly extract the importances of super-features 131-133 from surrogate model 145. For example if surrogate model 145 is a decision tree or a linear regression, coefficients of the linear regression or level numbers of the decision tree may be more or less directly used as importance scores of super-features 131-133.

For horizontal scaling, steps 203-205 may be concurrently performed by a separate execution context respectively for each of super-features 131-133. An execution context may be based on a lightweight thread, an operating system process, a hyper thread, a processing core of a central processing unit (CPU), a CPU, a coprocessor, and/or a separate computer.

In an embodiment, importance scores of super-features 131-133 are used for feature selection for target ML model design and configuration instead of for MLX. For example if super-feature 131 is the least important, then features F1-F2 of super-feature 131 may be excluded from feature selection. An embodiment that is not for MLX does not perform step 208.

Step 208 generates a local explanation of ML model 160 based on tuple to explain T5. Step 208 may: a) rank super-features 131-133 and retain their respective importance scores, b) discard neighborhood 140, and c) generate a local MLX explanation for tuple to explain T5 as discussed earlier herein.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

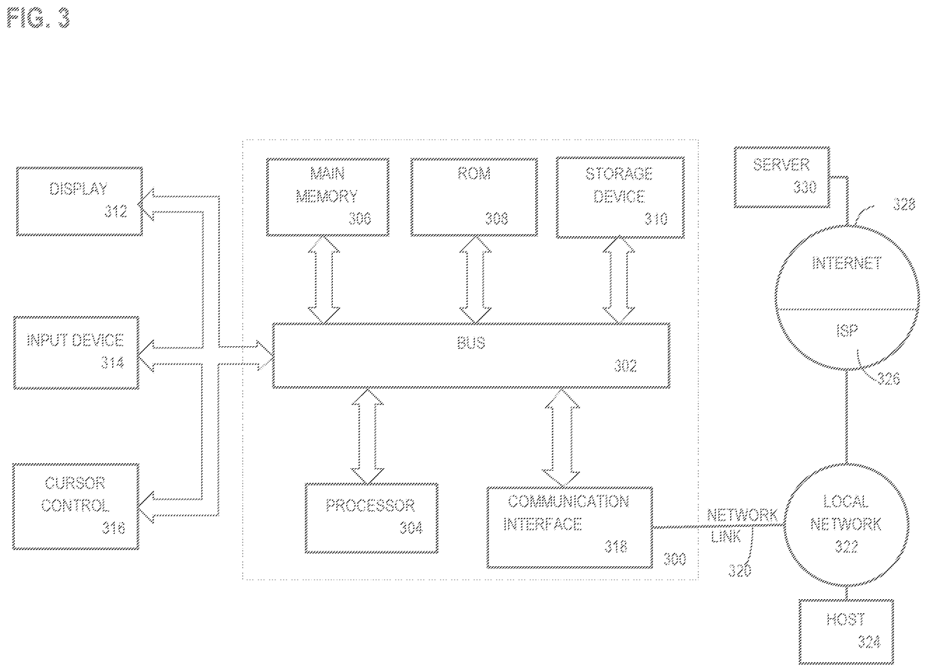

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

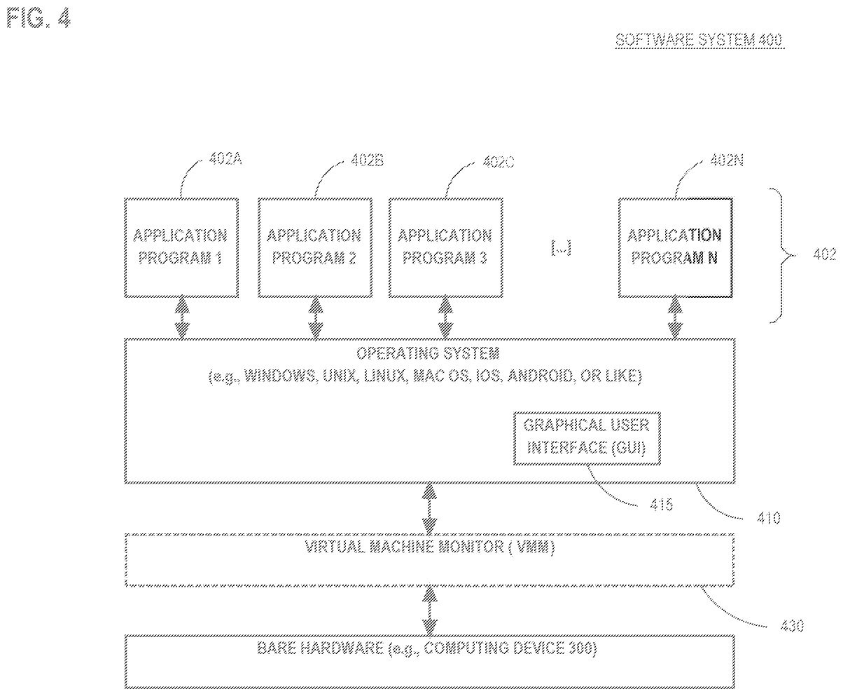

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 300 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C #, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
defining a plurality of super-features that each contain a respective disjoint subset of features of a plurality of features;
a machine learning (ML) model inferring a particular inference for a particular tuple that is based on the plurality of features;
for each super-feature of the plurality of super-features:
randomly selecting a plurality of permuted values from original values of the super-feature in a plurality of original tuples that are based on the plurality of features,
generating a plurality of permuted tuples, wherein each permuted tuple of the plurality of permuted tuples is based on said particular tuple and a respective permuted value of the plurality of permuted values, and
the ML model inferring a respective permuted inference for each permuted tuple of the plurality of permuted tuples;
training, based on the permuted inferences, a surrogate model;
calculating, for each super-feature of the plurality of super-features, an importance of the super-feature based on the surrogate model.

2. The method of claim 1 further comprising accessing the value of a super-feature of an original tuple of the plurality of original tuples based on at least one selected from the group consisting of:
an offset of the original tuple in an array that consists of the plurality of original tuples,
a range of offsets of the values of the subset of features of the super-feature that are contiguously stored in the original tuple, and
an offset into an array that consists of values the subset of features of the super-feature of the plurality of original tuples.

3. The method of claim 1 wherein at least one selected from the group consisting of:
the plurality of super-features respectively correspond to a plurality of modalities, and
a first super-feature of the plurality of super-features contains more features than a second super-feature of the plurality of super-features.

4. The method of claim 1 further comprising generating a local explanation of the ML model based on said particular tuple.

5. The method of claim 4 wherein said generating the local explanation of the ML model is based on the importance of at least one super-feature of the plurality of super-features.

6. The method of claim 5 wherein the local explanation comprises a ranking of at least two super-features of the plurality of super-features based on the importances of the at least two super-features.

7. The method of claim 1 wherein at least one selected from the group consisting of:
said plurality of original tuples does not include said particular tuple,
the values of a particular super-feature of the plurality of super-features of the plurality of original tuples do not contain a value of the particular super-feature in the particular tuple, and
the values of the plurality of features in the plurality of original tuples do not contain the value of a particular feature of the plurality of features in the particular tuple.

8. The method of claim 1 wherein a particular super-feature of the plurality of super-features represents one selected from the group consisting of: a database connection, a database table, query criteria, a result of a database statement, and a kind of database statement.

9. The method of claim 1 wherein said training the surrogate model comprises populating at least one selected from the group consisting of:
a feature vector that identifies at least one original tuple of the plurality of original tuples,
a feature vector that identifies the particular tuple,
a feature vector that does not contain a Boolean,
a feature vector that contains at least one array offset, and
a feature vector that contains only integers.

10. The method of claim 1 wherein at least one selected from the group consisting of:
the ML model is unsupervised, and
the plurality of original tuples are unlabeled.

11. One or more non-transitory computer-readable media storing instructions that, when executed by one or more processors, cause:
defining a plurality of super-features that each contain a respective disjoint subset of features of a plurality of features;
a machine learning (ML) model inferring a particular inference for a particular tuple that is based on the plurality of features;
for each super-feature of the plurality of super-features:
randomly selecting a plurality of permuted values from original values of the super-feature in a plurality of original tuples that are based on the plurality of features,
generating a plurality of permuted tuples, wherein each permuted tuple of the plurality of permuted tuples is based on said particular tuple and a respective permuted value of the plurality of permuted values, and
the ML model inferring a respective permuted inference for each permuted tuple of the plurality of permuted tuples;
training, based on the permuted inferences, a surrogate model;
calculating, for each super-feature of the plurality of super-features, an importance of the super-feature based on the surrogate model.

12. The one or more non-transitory computer-readable media of claim 11 wherein the instructions further cause accessing the value of a super-feature of an original tuple of the plurality of original tuples based on at least one selected from the group consisting of:
an offset of the original tuple in an array that consists of the plurality of original tuples,
a range of offsets of the values of the subset of features of the super-feature that are contiguously stored in the original tuple, and
an offset into an array that consists of values the subset of features of the super-feature of the plurality of original tuples.

13. The one or more non-transitory computer-readable media of claim 11 wherein at least one selected from the group consisting of:
the plurality of super-features respectively correspond to a plurality of modalities, and
a first super-feature of the plurality of super-features contains more features than a second super-feature of the plurality of super-features.

14. The one or more non-transitory computer-readable media of claim 11 wherein the instructions further cause generating a local explanation of the ML model based on said particular tuple.

15. The one or more non-transitory computer-readable media of claim 14 wherein said generating the local explanation of the ML model is based on the importance of at least one super-feature of the plurality of super-features.

16. The one or more non-transitory computer-readable media of claim 15 wherein the local explanation comprises a ranking of at least two super-features of the plurality of super-features based on the importances of the at least two super-features.

17. The one or more non-transitory computer-readable media of claim 11 wherein at least one selected from the group consisting of:
said plurality of original tuples does not include said particular tuple,
the values of a particular super-feature of the plurality of super-features of the plurality of original tuples do not contain a value of the particular super-feature in the particular tuple, and
the values of the plurality of features in the plurality of original tuples do not contain the value of a particular feature of the plurality of features in the particular tuple.

18. The one or more non-transitory computer-readable media of claim 11 wherein a particular super-feature of the plurality of super-features represents one selected from the group consisting of: a database connection, a database table, query criteria, a result of a database statement, and a kind of database statement.

19. The one or more non-transitory computer-readable media of claim 11 wherein said training the surrogate model comprises populating at least one selected from the group consisting of:
a feature vector that identifies at least one original tuple of the plurality of original tuples,
a feature vector that identifies the particular tuple,
a feature vector that does not contain a Boolean,
a feature vector that contains at least one array offset, and
a feature vector that contains only integers.

20. The one or more non-transitory computer-readable media of claim 11 wherein at least one selected from the group consisting of:
the ML model is unsupervised, and
the plurality of original tuples are unlabeled.
